(19) United States
(12) Patent Application Publication
(10) Pub. No.: US 2023/0385954 A1
(43) Pub. Date: Nov. 30, 2023

(54) SOCIAL MEDIA GAME

(71) Applicant: Cub3 Inc., Los Angeles, CA (US)

(72) Inventors: Mrudul Bindu Bhatt, Liverpool (GB); Lincoln Gasking, Los Angeles, CA (US)

(21) Appl. No.: 17/826,105

(22) Filed: May 26, 2022

(51) Int. Cl. G06Q 50/00

(52) U.S. Cl. CPC G06Q 50/01

(57) ABSTRACT

A machine incentivizes behavior, for example, by facilitating a social media game. To facilitate such a game, the machine generates a notification that social media followers of a social media user with a corresponding blockchain will obtain consequences for performing a task that corresponds to the social media user. The machine provides the notification to at least a portion of the social media followers. The machine verifies that a subset of the social media followers have performed the task, each to a corresponding extent of performance. The machine determines, for each social media follower in the verified subset, a corresponding consequence based on the corresponding extent of performance. The machine then updates the blockchain to include a set of one or more data blocks that each indicates a corresponding verified social media follower, the corresponding extent of performance, and the determined corresponding consequence.

### TECHNICAL FIELD

The subject matter disclosed herein generally relates to the technical field of special-purpose machines that facilitate an incentivizing of behavior of people, such as in playing or otherwise participating in a social media game, including software-configured computerized variants of such special-purpose machines and improvements to such variants, and to the technologies by which such special-purpose machines become improved compared to other special-purpose machines that facilitate an incentivizing of behavior of people. Specifically, the present disclosure addresses systems and methods to facilitate a social media game.

### BACKGROUND

A machine may be configured to interact with one or more users by generating one or more notifications (e.g., messages), providing such notifications to the users or otherwise causing such notifications to be provided to the users via corresponding devices, and receiving or otherwise detecting responses of the users to the provided notifications. For example, such a machine may generate and provide a request that a set of users sign an online petition, and the machine may receive or otherwise detect responses generated by a subset of those users via their corresponding user devices, and the responses may indicate whether each responding user signed the online petition.

### BRIEF DESCRIPTION OF THE DRAWINGS

Some embodiments are illustrated by way of example and not limitation in the figures of the accompanying drawings.

FIG. 1 is a network diagram illustrating a network environment suitable for facilitating (e.g., operating, providing, or participating in) a social media game, according to some example embodiments.

FIG. 2 is a block diagram illustrating components of a server machine suitable for facilitating a social media game, according to some example embodiments.

FIG. 3 is a block diagram illustrating components of a device suitable for facilitating a social media game, according to some example embodiments.

FIG. 4 is a block diagram illustrating relationships among a user (e.g., a social media user), first-order followers of the user, and second-order followers of the user, according to some example embodiments.

FIGS. 5-10 are flowcharts illustrating operations in performing a method of facilitating a social media game, according to some example embodiments.

FIG. 11 is a block diagram illustrating components of a machine, according to some example embodiments, able to read instructions from a machine-readable medium and perform any one or more of the methodologies discussed herein.

### DETAILED DESCRIPTION

Example methods (e.g., algorithms) facilitate a social media game or facilitate other forms of incentivizing behavior of people, and example systems (e.g., special-purpose machines configured by special-purpose software) are configured to facilitate a social media game or facilitate other forms of incentivizing behavior of people. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of various example embodiments. It will be evident to one skilled in the art, however, that the present subject matter may be practiced without these specific details.

A machine is configured (e.g., by suitable hardware, software, or a combination thereof) to incentivize behavior among people, for example, by facilitating (e.g., operating) a game, such as a social media game, in which the machine generates and uses notifications to motivate users to perform one or more actions (e.g., tasks) indicated in the notifications. In the context of operating a social media game, the machine generates a notification that social media followers of a social media user with a corresponding blockchain will obtain consequences for performing a task that corresponds to the social media user. The machine then provides the generated notification to at least a portion of the social media followers of the social media user that corresponds to the blockchain. Subsequently, the machine verifies that a subset of the social media followers have performed the task that corresponds to the social media user, each to a corresponding extent of performance of the task. The machine then determines, for each social media follower in the verified subset of the social media followers, a corresponding consequence based on the corresponding extent of performance of the task performed by that social media follower. Based on these determinations, the machine updates the blockchain that corresponds to the social media user to include a set of one or more data blocks that each indicates (1) a corresponding social media follower among the verified subset of the social media followers, (2) the corresponding extent of performance of the task performed by that social media follower, and (3) the determined corresponding consequence for that social media follower.

More generally speaking, a machine configured according to the systems and methods discussed herein may facilitate a solution to a problem, where the solution can take the form of a goal that can be met by incentivizing (e.g., rewarding) behaviors of people. For example, the goal may be an environmental goal (e.g., a rainforest in a specified region is still alive at the end of a specified period of time, such as up through the year 2035), and the goal may be represented by one or more indicators (e.g., key performance indicators) that each indicate a corresponding extent (e.g., degree or level) of success in a corresponding dimension of that goal. It may be unspecified by the machine how to achieve the goal, and it may be initially unknown to the people how to achieve the goal. However, the machine may determine a set of one or more parameters (e.g., rules or constraints) for achieving the goal and then announce (e.g., via notifications) a consequence (e.g., a bounty or other reward) to be issued if the goal is achieved. In some example embodiments, the machine accesses such a set of one or more parameters (e.g., an input to a game generation process that results in operating a suitable game for incentivizing behavior of people towards accomplishing the goal). In certain example embodiments, the incentivized behavior is performed by non-human agents (e.g., automated devices or other machines), humans (e.g., people), or a combination thereof. Accordingly, the machine is configured to incentivize (e.g., motivate) a population of agents to achieve a goal within a set of parameters (e.g., rules, constraints, or boundaries).

As an example of a general methodology to configure such a machine, the following sequence of operations may be performed (e.g., by human configurators of the machine, by an artificial intelligence engine configured to configure the machine, or by any suitable combination thereof). To begin, a first-order problem to be solved is defined for the machine. In this context, the term “first-order” refers to a measurable goal (e.g., a metric) to be influenced (e.g., achieved or improved) as a primary outcome for which the machine is to be configured. In typical situations, there may be some uncertainty regarding how the first-order problem is to be solved, who will solve the first-order problem, or both. Next, the reward for solving the first-order problem is defined for the machine to provide to the ultimate solver of the first-order problem. In some example situations, the defined reward may be placed (e.g., by the configured machine) into escrow or otherwise made subject to an accountable system of management or distribution.

Then, a path for input of second-order solutions to the first-order problem is created for the machine to offer to would-be solvers (e.g., human agents, machine agents, or both) of the first-order problem. In this context, the term “second-order” refers to the influences on the measurable goal (e.g., the first-order problem). For example, the machine may allocate (e.g., distribute) specified amounts of work (e.g., a task) to be performed among responding would-be solvers, and the machine may (e.g., after verifying performance of the amounts of work) allocate the reward or a specified portion thereof at random among those would-be solvers whose performances were verified. As another example, the machine may offer an instance among multiple instances of the reward to all would-be solvers who perform a specified action (e.g., a task, such as share a specified code or word to one or more followers via one or more social media services).

The machine may be further configured to identify, authenticate, verify, or otherwise ascertain each would-be solver, an extent to which each corresponding action has been performed, or any suitable combination thereof. According to some example embodiments, the machine is configured to determine (e.g., calculate or assign) a corresponding value to each extent of performance (e.g., and thus its corresponding solution), make comparisons of each determined value to other values for other extents of performance, and allocate the reward or one or more portions (e.g., instances) thereof based on such comparisons. In certain example embodiments, the machine determines that a determined value is an extremum value (e.g., a maximum value or a minimum value) among the determined values and allocates the reward or one or more portions thereof based on that determined value being an extremum value. According to various example embodiments, the machine determines (e.g., calculates) a level of divergence (e.g., Kullback-Leibler divergence) or other measure of surprise (e.g., surprisingness) for corresponding extent of performance and its corresponding solution, and the machine may allocate the reward or one or more portions thereof based on the level of divergence or other measure of surprise.

In some example embodiments, a dynamic feedback loop further configures the machine based on the solution (e.g., deemed as a best solution) that corresponds to the extremum value for the corresponding extent of performance. For example, the machine may be configured (e.g., reconfigured) by this feedback process to create an improved game (e.g., social media game) based on that solution (e.g., by modifying the set of parameters to further constrain the acceptable solutions to the first-order problem). Accordingly, the machine may be improved over time, or improve itself over time, with respect to solving the first-order problem.

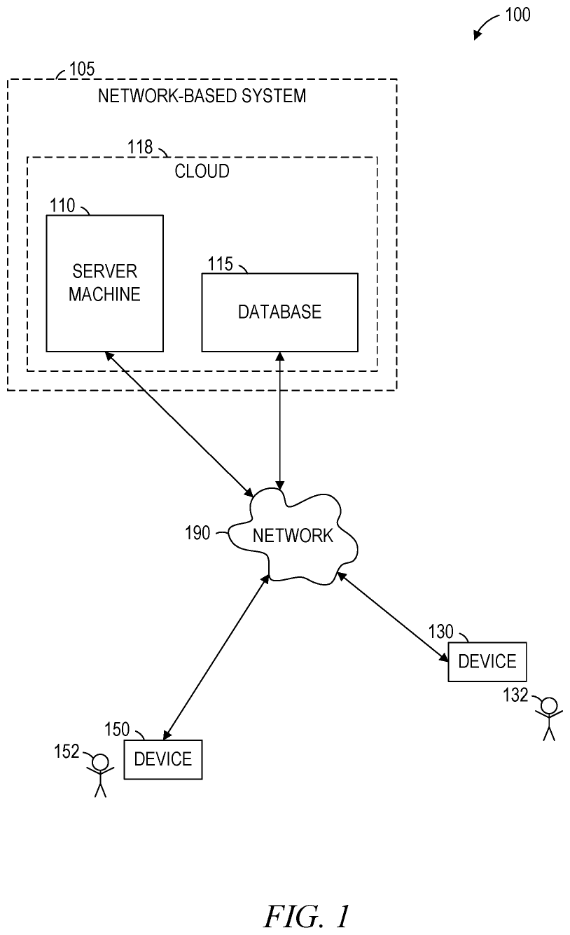

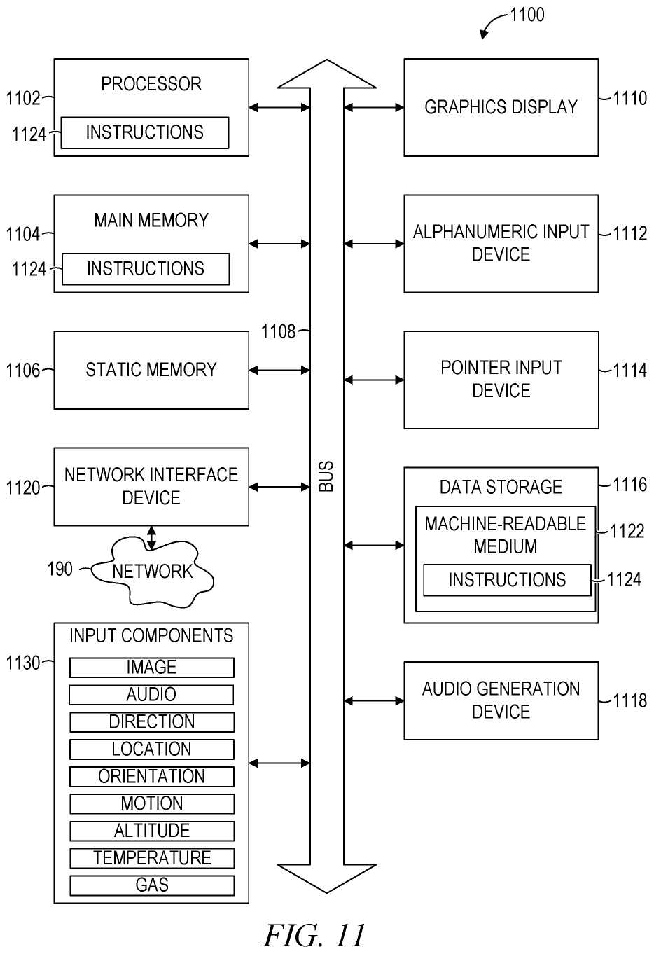

FIG. 1 is a network diagram illustrating a network environment 100 suitable for facilitating (e.g., operating, providing, or participating in) a social media game, according to some example embodiments. The network environment 100 includes a server machine 110, a database 115, and devices 130 and 150, all communicatively coupled to each other via a network 190. The server machine 110, with or without the database 115, may form all or part of a cloud 118 (e.g., a geographically distributed set of multiple machines configured to function as a single server), which may form all or part of a network-based system 105 (e.g., a cloud-based server system configured to provide one or more network-based services to the devices 130 and 150). The server machine 110, the database 115, and the devices 130 and 150 may each be implemented in a special-purpose (e.g., specialized) computer system, in whole or in part, as described below with respect to FIG. 11.

Also shown in FIG. 1 are users 132 and 152. One or both of the users 132 and 152 may be a human user (e.g., a human being), a machine user (e.g., a computer configured by a software program to interact with the device 130 or 150), or any suitable combination thereof (e.g., a human assisted by a machine or a machine supervised by a human). The user 132 is associated with the device 130 and may be a user of the device 130. For example, the device 130 may be a desktop computer, a vehicle computer, a home media system (e.g., a home theater system or other home entertainment system), a tablet computer, a navigational device, a portable media device, a smart phone, or a wearable device (e.g., a smart watch, smart glasses, smart clothing, or smart jewelry) belonging to the user 132. Likewise, the user 152 is associated with the device 150 and may be a user of the device 150. As an example, the device 150 may be a desktop computer, a vehicle computer, a home media system (e.g., a home theater system or other home entertainment system), a tablet computer, a navigational device, a portable media device, a smart phone, or a wearable device (e.g., a smart watch, smart glasses, smart clothing, or smart jewelry) belonging to the user 152.

Any of the systems or machines (e.g., databases and devices) shown in FIG. 1 may be, include, or otherwise be implemented in a special-purpose (e.g., specialized or otherwise non-conventional and non-generic) computer that has been modified to perform one or more of the functions described herein for that system or machine (e.g., configured or programmed by special-purpose software, such as one or more software modules of a special-purpose application, operating system, firmware, middleware, or other software program). For example, a special-purpose computer system able to implement any one or more of the methodologies described herein is discussed below with respect to FIG. 11, and such a special-purpose computer may accordingly be a means for performing any one or more of the methodologies discussed herein. Within the technical field of such special-purpose computers, a special-purpose computer that has been specially modified (e.g., configured by special-purpose software) by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

As used herein, a “database” is a data storage resource and may store data structured in any of various ways, for example, as a text file, a table, a spreadsheet, a relational database (e.g., an object-relational database), a triple store, a hierarchical data store, a document database, a graph database, key-value pairs, or any suitable combination thereof. Moreover, any two or more of the systems or machines illustrated in FIG. 1 may be combined into a single system or machine, and the functions described herein for any single system or machine may be subdivided among multiple systems or machines.

The network 190 may be any network that enables communication between or among systems, machines, databases, and devices (e.g., between the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone service (POTS) network), a wireless data network (e.g., a WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

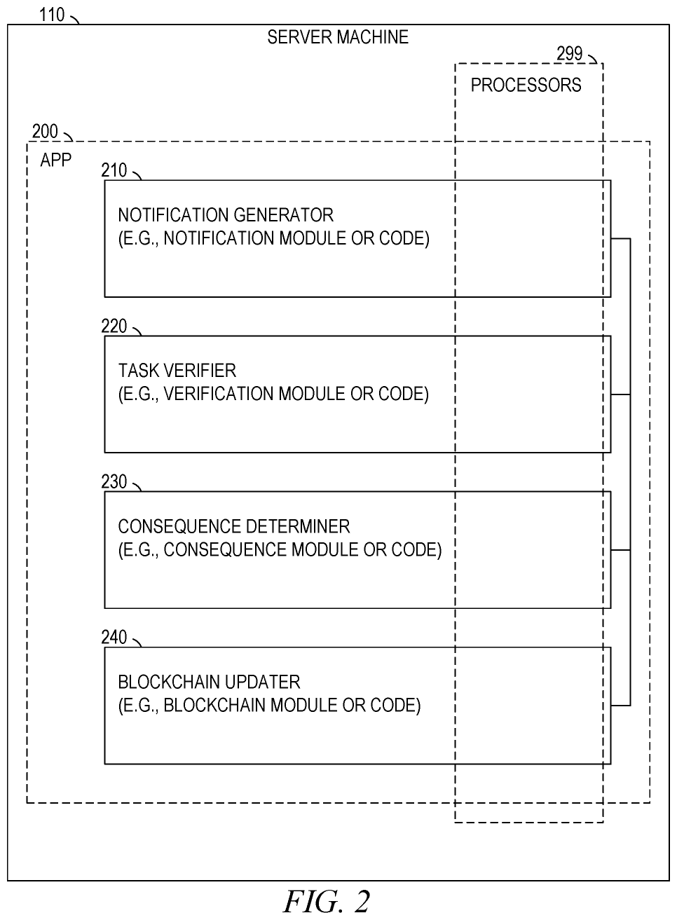

FIG. 2 is a block diagram illustrating components of the server machine 110, as configured for facilitating a social media game, according to some example embodiments. The server machine 110 is shown as including a notification generator 210 (e.g., a notification module or suitable code for generating notifications), a task verifier 220 (e.g., a verification module or suitable code for verifying performances of tasks), a consequence determiner 230 (e.g., a consequence module or suitable code for determining consequences), and a blockchain updater 240 (e.g., a blockchain module or suitable code for updating blockchains), all configured to communicate with each other (e.g., via a bus, shared memory, or a switch).

As shown in FIG. 2, the notification generator 210, the task verifier 220, the consequence determiner 230, and the blockchain updater 240 may form all or part of an app 200 (e.g., a server-side app) that is stored (e.g., installed) on the server machine 110 (e.g., responsive to or otherwise as a result of data being received from the database 115, or other suitable data source, via the network 190). Furthermore, one or more processors 299 (e.g., hardware processors, digital processors, or any suitable combination thereof) may be included (e.g., temporarily or permanently) in the app 200, the notification generator 210, the task verifier 220, the consequence determiner 230, the blockchain updater 240, or any suitable combination thereof.

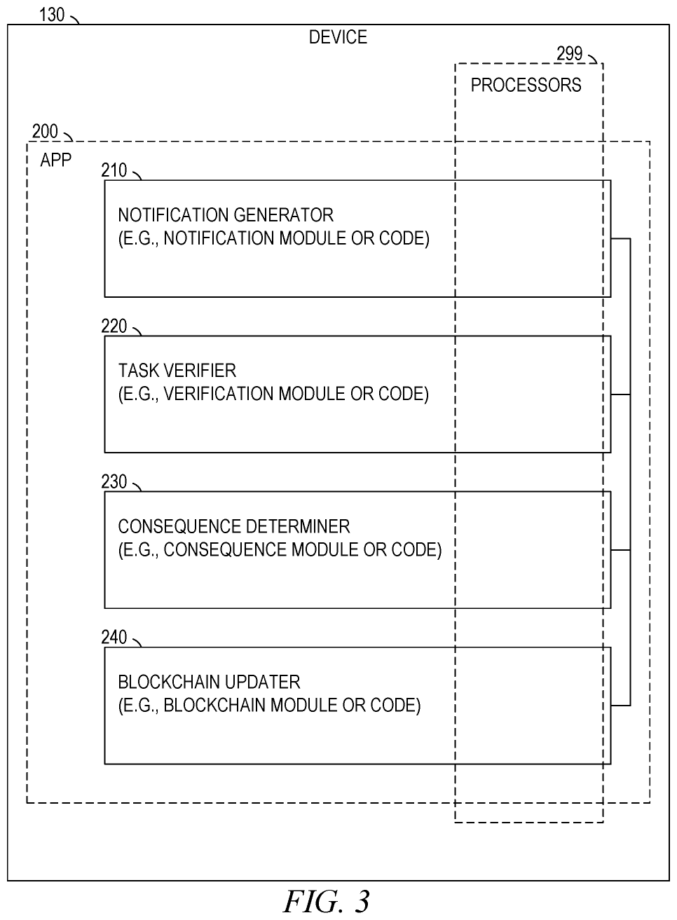

FIG. 3 is a block diagram illustrating components of the device 130, as configured for facilitating a social media game, according to some example embodiments. The device 130 is shown as including the notification generator 210 (e.g., a notification module or suitable code for generating notifications), the task verifier 220 (e.g., a verification module or suitable code for verifying performances of tasks), the consequence determiner 230 (e.g., a consequence module or suitable code for determining consequences), and the blockchain updater 240 (e.g., a blockchain module or suitable code for updating blockchains), all configured to communicate with each other (e.g., via a bus, shared memory, or a switch).

As shown in FIG. 3, the notification generator 210, the task verifier 220, the consequence determiner 230, and the blockchain updater 240 may form all or part of the app 200 (e.g., a client-side app) that is stored (e.g., installed) on the device 130 (e.g., responsive to or otherwise as a result of data being received from the database 115, or other suitable data source, via the network 190). Furthermore, one or more processors 299 (e.g., hardware processors, digital processors, or any suitable combination thereof) may be included (e.g., temporarily or permanently) in the app 200, the notification generator 210, the task verifier 220, the consequence determiner 230, the blockchain updater 240, or any suitable combination thereof.

Furthermore, the device 150 shown in FIG. 1 may be configured in a manner similar to the server machine 110, as discussed above with respect to FIG. 2, similar to the device 130, as discussed above with respect to FIG. 3, or similar to both.

Any one or more of the components (e.g., modules) described herein may be implemented using hardware alone (e.g., one or more of the processors 299) or a combination of hardware and software. For example, any component described herein may physically include an arrangement of one or more of the processors 299 (e.g., a subset of or among the processors 299) configured to perform the operations described herein for that component. As another example, any component described herein may include software, hardware, or both, that configure an arrangement of one or more of the processors 299 to perform the operations described herein for that component. Accordingly, different components described herein may include and configure different arrangements of the processors 299 at different points in time or a single arrangement of the processors 299 at different points in time. Each component (e.g., module) described herein is an example of a means for performing the operations described herein for that component. Moreover, any two or more components described herein may be combined into a single component, and the functions described herein for a single component may be subdivided among multiple components. Furthermore, according to various example embodiments, components described herein as being implemented within a single system or machine (e.g., a single device) may be distributed across multiple systems or machines (e.g., multiple devices).

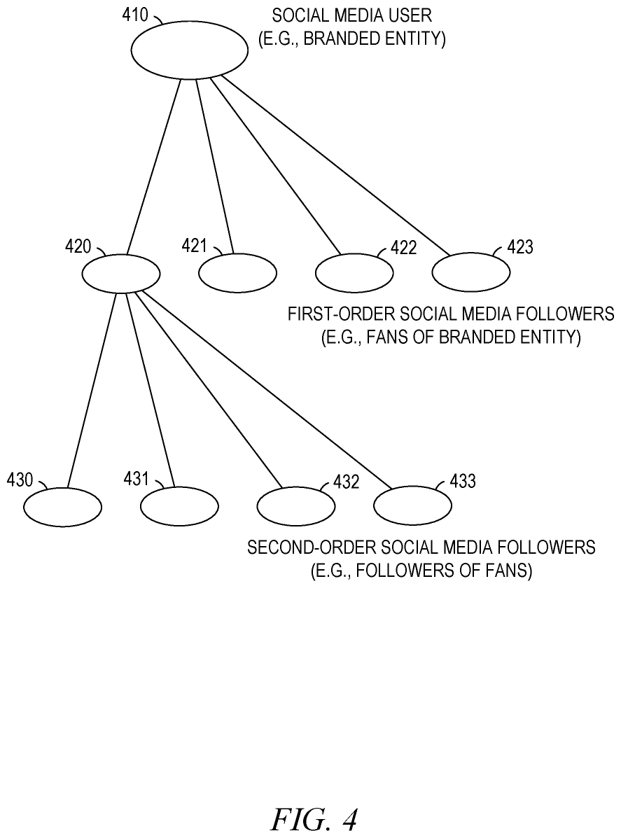

FIG. 4 is a block diagram illustrating relationships among a user (e.g., a branded entity, such as a shoe company or a rock band, that uses one or more social media services), first-order followers of that user (e.g., followers of the branded entity, such as the user 132 of the device 130), and second-order followers of that user (e.g., followers of the followers of the branded entity, such as the user 152 of the device 150), according to some example embodiments. As shown in FIG. 4, a social media user 410 (e.g., a branded entity, such as a soda company or a celebrity) has first-order followers 420, 421, 422, and 423 directly linked via one or more social media services (e.g., provided by one or more social media networks, one or more social media platforms, or any suitable combination thereof). The social media user 410 may also have a corresponding blockchain (e.g., a distributed ledger), which may be automatically maintained, updated, and verified by a peer-to-peer cloud or other network of machines (e.g., the server machine 110, the device 130, the device 150, or any suitable combination thereof). Accordingly, the social media user 410 may be represented, fully or partially, by corresponding blockchain for the social media user 410. As examples, ways for a social media user to have a corresponding blockchain include having (e.g., possessing or otherwise being indicated within a blockchain as possessing) a corresponding blockchain wallet, a corresponding blockchain identifier (e.g., a blockchain ID), or any suitable combination thereof.

Each one of the first-order followers 420, 421, 422, and 423 may have its (e.g., his or her) own first-order followers directly linked via one or more social media services, and such first-order followers of a first-order follower (e.g., first-order follower 420) of the social media user 410 (e.g., the branded entity) may be considered as indirectly linked, second-order followers 430, 431, 432, and 433 of the social media user 410 (e.g., the branded entity). For example, if the social media user 410 is a branded entity (e.g., a metropolitan symphony orchestra), then the directly linked first-order followers 420, 421, 422, and 423 of the social media user 410 may be fans of the branded entity, while the indirectly linked second-order followers 430, 431, 432, and 433 of the social media user 410 may be directly linked followers of one of the fans of the branded entity.

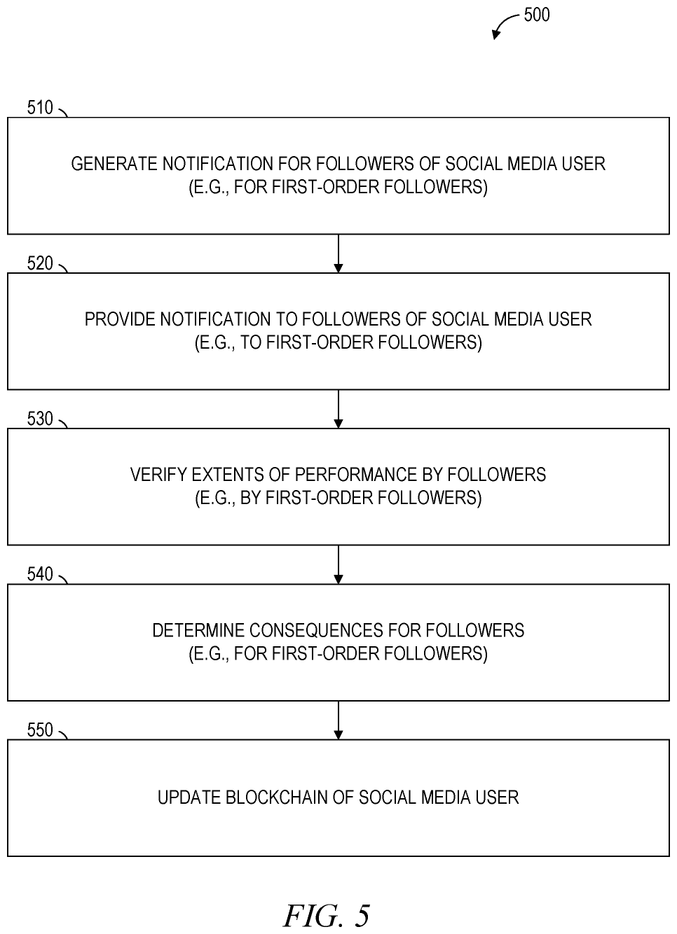

FIGS. 5-10 are flowcharts illustrating operations in performing a method 500 of facilitating a social media game, as an example of incentivizing behavior, according to some example embodiments. Operations in the method 500 may be performed by the server machine 110, the device 130, the device 150, or any suitable combination thereof, using components (e.g., modules) described above with respect to FIGS. 2 and 3, using one or more processors (e.g., microprocessors or other hardware processors), or using any suitable combination thereof. As shown in FIG. 5, the method 500 includes operations 510, 520, 530, 540, and 550.

In operation 510, the notification generator 210 generates (e.g., creates) a notification (e.g., a message) stating that social media followers of the social media user 410, who has a corresponding blockchain, will obtain consequences for performing a task that corresponds to the social media user 410.

In operation 520, the notification generator 210 provides (e.g., sends or otherwise causes receipt of) the generated notification to at least a portion of the social media followers (e.g., first-order followers 420, 421, 422, and 423) of the social media user 410 that corresponds to the blockchain. For example, the task may include generating a personal video of oneself speaking a keyword or catchphrase that corresponds to the social media user 410, performing a dance move that corresponds to the social media user 410, or both, and then sharing the generated personal video with at least ten (10) of one's own followers (e.g., second-order followers 430, 431, 432, and 433) of the social media user 410.

In operation 530, the task verifier 220 verifies that a subset of the social media followers (e.g., a subset of first-order followers 420, 421, 422, and 423) performed the task that corresponds to the social media user 410, each to a corresponding extent of performance of the task. Continuing the previous example, the first-order follower 420 may have generated his or her corresponding personal video and shared it with ten (10) of his or her own followers; the first-order follower 421 may have generated his or her corresponding personal video and shared it with fifteen (15) of his or her own followers; the first-order follower 422 may have generated his or her corresponding personal video and shared it with only six (6) of his or her own followers; and the first-order follower 423 may have failed to generate his or her corresponding personal video. In such a situation, only the first-order followers 420 and 421 would be verified to have performed the task, with the first-order follower 421 having a greater corresponding extent of performance (e.g., fifteen (15) shares of his or her personal video) than the first-order follower 420 (e.g., ten (10) shares of his or her personal video).

In operation 540, the consequence determiner 230 determines, for each social media follower in the verified subset of the social media followers, a corresponding consequence based on the corresponding extent of performance of the task performed by that social media follower. Continuing the previous example, the consequence determiner 230 may determine that one or more first-order followers (e.g., the first-order followers 420 and 421) are to be rewarded (e.g., with merchandise or a special privilege from the branded entity) for performing the task, each to his or her respectively corresponding extent of performance. Accordingly, the consequence determiner 230 may determine that the first-order follower 421 is to be rewarded to a greater extent than the first-order follower 420.

In operation 550, the blockchain updater 240 updates the blockchain that corresponds to the social media user 410 to include a set of one or more data blocks that each indicates a corresponding social media follower (e.g., the first-order follower 421) among the verified subset of the social media followers. Each data block may also indicate the corresponding extent of performance of the task performed by that social media follower (e.g., fifteen (15) downstream followers with whom the corresponding personal video was shared). Each data block may further indicate the determined corresponding consequence (e.g., a free sweatshirt branded by the branded entity or free tickets to an event that will feature the branded entity) for that social media follower.

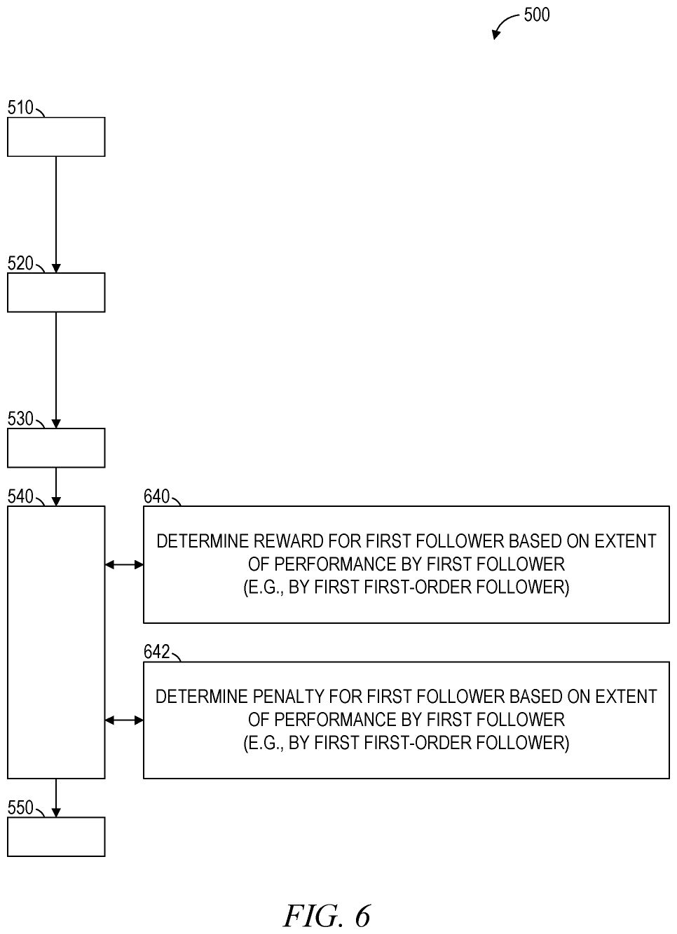

As shown in FIG. 6, in addition to any one or more of the operations previously described, the method 500 may include one or more of operations 640 and 642. One or more of operations 640 and 642 may be performed as part (e.g., a precursor task, a subroutine, or a portion) of operation 540, in which the consequence determiner 230 determines corresponding consequences (e.g., rewards, penalties, or both) for the social media followers in the verified subset of the social media followers based on their corresponding extents of performance of the task that corresponds to the social media user 410.

In operation 640, the consequence determiner 230 determines a reward (e.g., merchandise of the branded entity or event tickets corresponding to the branded entity) for one or more of the social media followers in the verified subset of the social media followers. In each instance, the determined reward may be based on that corresponding social media follower's corresponding extent of performance in performing the task that corresponds to the social media user 410.

In operation 642, the consequence determiner 230 determines a penalty (e.g., loss of loyalty points corresponding to the branded entity) for one or more of the social media followers in the verified subset of the social media followers. In each instance, the determined penalty may be based on that corresponding social media follower's corresponding extent of performance in performing the task that corresponds to the social media user 410.

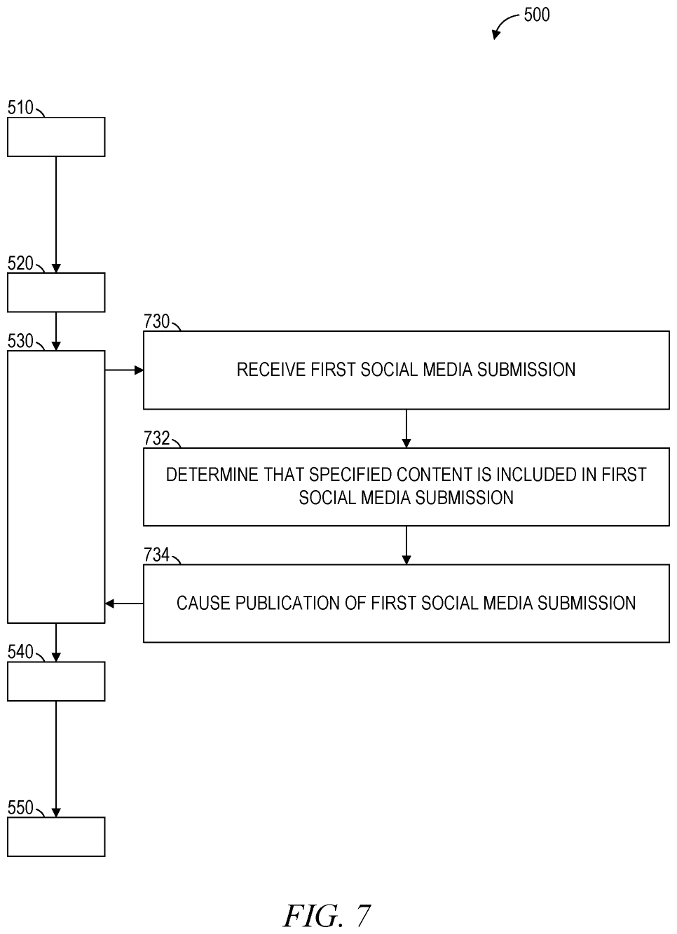

As shown in FIG. 7, in addition to any one or more of the operations previously described, the method 500 may include one or more of operations 730, 732, and 734. One or more of operations 730, 732, and 734 may be performed as part (e.g., a precursor task, a subroutine, or a portion) of operation 530, in which the task verifier 220 verifies that the subset of the social media followers (e.g., a subset of first-order followers 420, 421, 422, and 423) performed the task that corresponds to the social media user 410, each to a corresponding extent of performance.

In operation 730, the task verifier 220 receives or otherwise accesses a social media submission that was sent from a device (e.g., device 130) of a social media follower (e.g., first-order follower 420, which may be the user 132) of the social media user 410. For example, if the task to be performed is to create a personal video of oneself speaking a keyword or catchphrase that corresponds to the social media user 410, then here the task verifier 220 may intercept or otherwise access such a personal video after the social media follower (e.g., first-order follower 420) initiates a submitting (e.g., a posting) of the personal video to one or more social media services.

In operation 732, the task verifier 220 determines that the social media submission (e.g., as received in operation 730) includes at least one of speech content specified in the generated notification, image content specified in the generated notification, or video content specified in the generated notification. Continuing the above example where the task to be performed is to create a personal video of oneself speaking a keyword or catchphrase that corresponds to the social media user 410, here the task verifier 220 may run one or more speech recognition algorithms, one or more image recognition algorithms, one or more video recognition algorithms (e.g., with lip reading capabilities), or any suitable combination thereof, and check whether that keyword or catchphrase is spoken (e.g., at least to a threshold degree of accuracy, precision, recognizability, or any suitable combination thereof) in the intercepted or otherwise accessed personal video submitted (e.g., for posting) by that social media follower (e.g., first-order follower 420).

In operation 734, the task verifier 220 causes publication of the social media submission (e.g., as determined to include the specified speech content, image content, video content, or any suitable combination thereof, in operation 732) by a social media account that corresponds to the social media follower (e.g., first-order follower 420) of the social media user 410. Continuing the above example where the task to be performed is to create a personal video of oneself speaking a keyword or catchphrase that corresponds to the social media user 410, here the task verifier 220 may cause publication (e.g., posting) of the personal video by releasing the intercepted or otherwise accessed personal video to one or more social media services (e.g., subscribed or otherwise used by the first-order follower 420, which may be the user 132) or otherwise causing the personal video to become published (e.g., posted).

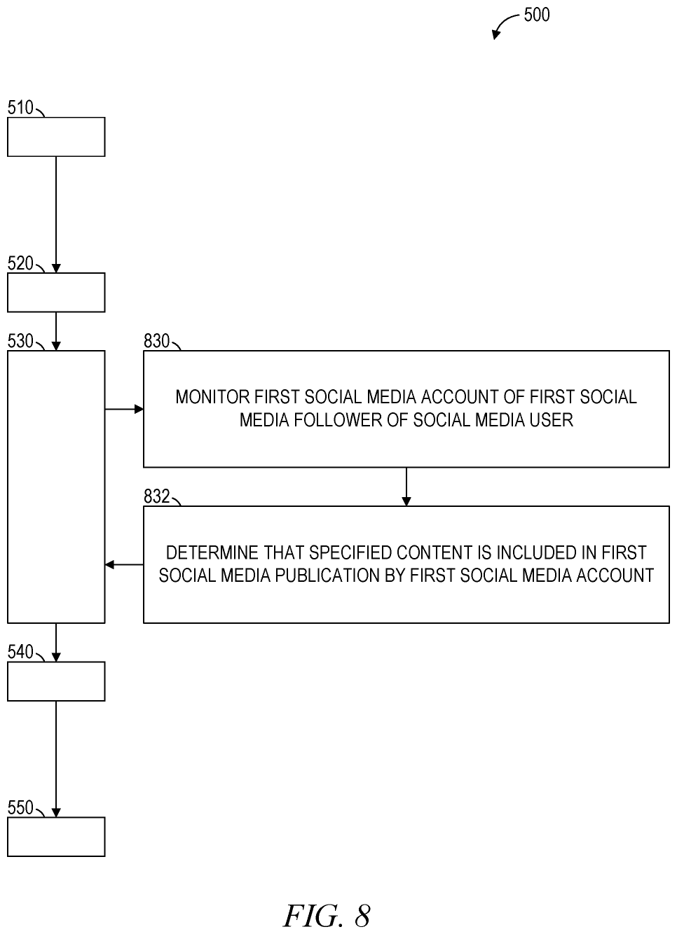

As shown in FIG. 8, in addition to any one or more of the operations previously described, the method 500 may include one or more of operations 830 and 832. One or more of operations 830 and 832 may be performed as part (e.g., a precursor task, a subroutine, or a portion) of operation 530, in which the task verifier 220 verifies that the subset of the social media followers (e.g., a subset of first-order followers 420, 421, 422, and 423) performed the task that corresponds to the social media user 410, each to a corresponding extent of performance.

In operation 830, the task verifier 220 monitors (e.g., by regularly or otherwise repeatedly polling or otherwise accessing) a social media account that corresponds to the social media follower (e.g., first-order follower 420) of the social media user 410. The task verifier 220 may monitor a single social media account of the social media follower (e.g., as provided by a single social media service), or the task verifier 220 may monitor multiple social media accounts of the social media follower (e.g., as provided by multiple social media services). Such monitoring of multiple social media accounts may be performed regularly or otherwise repeatedly (e.g., in unison or in a rotating manner). As part of the monitoring of the social media account, the task verifier 220 may specifically check for one or more indications that the social media follower performed the task that corresponds to the social media user 410 (e.g., to a corresponding extent of performance).

In operation 832, the task verifier 220 determines that a social media publication by the social media account that corresponds to the social media follower (e.g., first-order follower 420) includes at least one of speech content specified in the generated notification, image content specified in the generated notification, or video content specified in the generated notification. Continuing the above example where the task to be performed is to create a personal video of oneself speaking a keyword or catchphrase that corresponds to the social media user 410, here the task verifier 220 may access a posting that included the personal video and then run one or more speech recognition algorithms, one or more image recognition algorithms, one or more video recognition algorithms (e.g., with lip reading capabilities), or any suitable combination thereof, to check whether that keyword or catchphrase is spoken (e.g., at least to a threshold degree of accuracy, precision, recognizability, or any suitable combination thereof) in the personal video published (e.g., posted) by that social media follower (e.g., first-order follower 420).

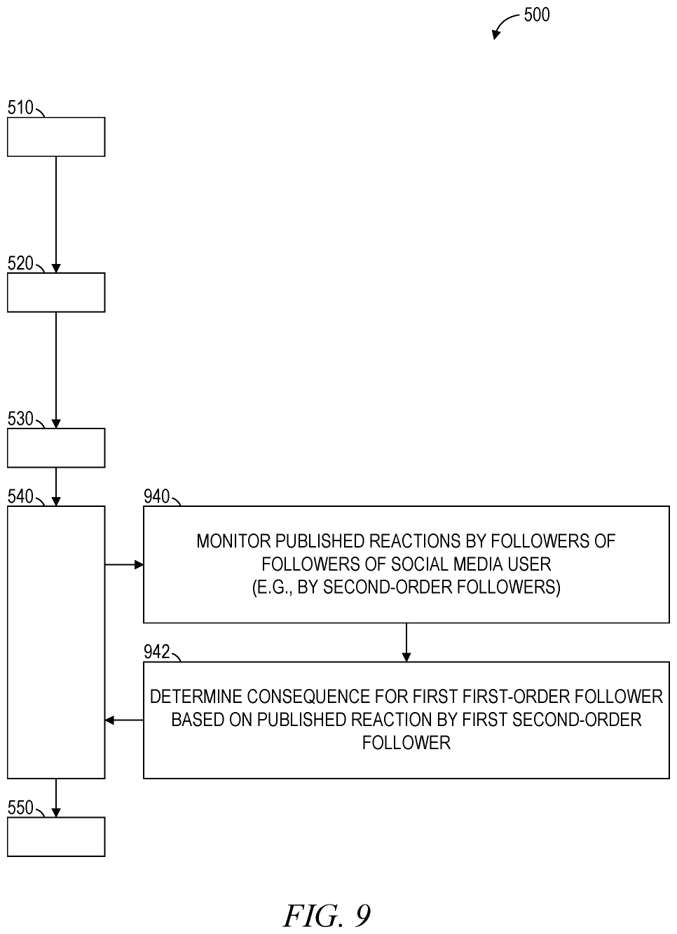

As shown in FIG. 9, in addition to any one or more of the operations previously described, the method 500 may include one or more of operations 940 and 942. One or more of operations 940 and 942 may be performed as part (e.g., a precursor task, a subroutine, or a portion) of operation 540, in which the consequence determiner 230 determines corresponding consequences (e.g., rewards, penalties, or both) for the social media followers in the verified subset of the social media followers based on their corresponding extents of performance of the task that corresponds to the social media user 410.

In operation 940, the consequence determiner 230 monitors (e.g., by regularly or otherwise repeatedly polling or otherwise accessing) one or more published reactions (e.g., likes, dislikes, comments, forwards, further shares, or reposts) by one or more social media followers (e.g., second-order followers 430, 431, 432, and 433) of one or more of the social media followers in the verified subset of the social media followers (e.g., first-order followers 420 and 421) of the social media user 410 (e.g., the branded entity). The consequence determiner 230 may monitor a single social media account of each one of multiple second-order followers (e.g., as provided by a single respective social media service to each second-order follower), or the consequence determiner 230 may monitor multiple social media accounts of each one of multiple second-order followers (e.g., as provided by multiple social media services respectively to each second-order follower). Such monitoring of multiple social media accounts may be performed regularly or otherwise repeatedly (e.g., in unison or in a rotating manner).

As part of the monitoring of any one social media account, the consequence determiner 230 may specifically check for one or more indications that the corresponding second-order follower published a reaction to a first-order follower's extent of performance in the task specified in the generated notification. Continuing the above example where the task to be performed is to create a personal video of oneself speaking a keyword or catchphrase that corresponds to the social media user 410, here the consequence determiner 230 may monitor one or more social media services and check for any published reactions (e.g., likes, dislikes, comments, forwards, further shares, or reposts) by second-order followers 430, 431, 432, and 433, in response to a posting that included the personal video generated by the first-order follower 420.

In operation 942, the consequence determiner 230 determines the corresponding consequence for a first-order follower (e.g., first-order follower 420) based on at least one published reaction (e.g., as detected in operation 940) by at least one of the second-order followers reacting to the corresponding performance of the task by the first-order follower (e.g., to the corresponding extent of performance by that first-order follower). Continuing the above example where the task to be performed is to create a personal video of oneself speaking a keyword or catchphrase that corresponds to the social media user 410, here the consequence determiner 230 may base the determination of the consequence for the first-order follower 420 on how many positive reactions (e.g., likes, forwards, reshares, or reposts, assignments of heart emojis, or assignments of happy emojis) were elicited by the posted personal video made by the first-order follower 420, how many negative reactions (e.g., dislikes, assignments of sad emojis, or assignments of angry emojis) were elicited by the posted personal video made by the first-order follower 420, or any suitable combination thereof.

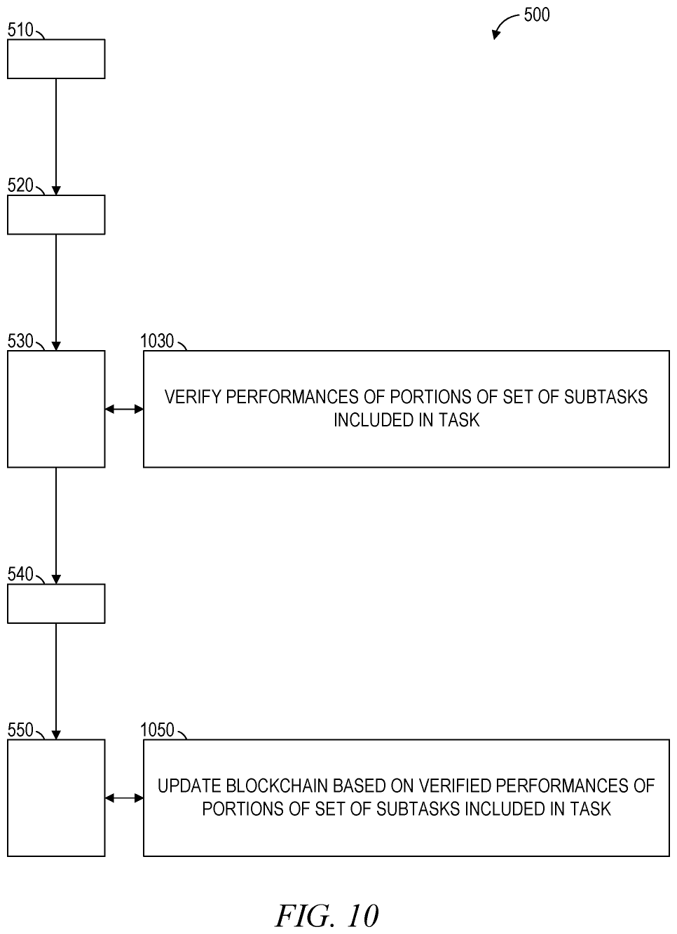

As shown in FIG. 10, in addition to any one or more of the operations previously described, the method 500 may include one or more of operations 1030 and 1050. Operation 1030 may be performed as part (e.g., a precursor task, a subroutine, or a portion) of operation 530, in which the task verifier 220 verifies that the subset of the social media followers (e.g., a subset of first-order followers 420, 421, 422, and 423) performed the task that corresponds to the social media user 410, each to a corresponding extent of performance. In example embodiments that include operation 1030, the notification generated in operation 510 additionally indicates a set of subtasks within the task that corresponds to the social media user 410.

In operation 1030, the task verifier 220 performs the above-described verification—that the subset of the social media followers each performed the task to his or her corresponding extent of performance—based on a corresponding portion (e.g., a performed portion) of the set of subtasks for (e.g., performed by) each social media follower in the subset of the social media followers (e.g., first-order followers 420, 421, and 422) of the social media user 410. For example, the generated notification may indicate that the task to be performed is to create a personal video of oneself speaking a set of multiple keywords or catchphrases (e.g., a set of five (5) catchphrases) that corresponds to the social media user 410, and the set of subtasks may specify a different subtask for each keyword or catchphrase. In such a situation, the task verifier 220 may verify that the first-order follower 420 created a personal video that depicts the first-order follower 420 speaking all of the multiple keywords or catchphrases (e.g., all five (5) out of five (5) catchphrases) that correspond to the social media user 410, may verify that the first-order follower 421 created a personal video that depicts the first-order follower 421 speaking only some and not all of the keywords or catchphrases (e.g., three (3) out of five (5) catchphrases), may verify that the first-order follower 422 failed to create such a personal video and thus failed to perform any of the multiple subtasks, or any suitable combination thereof.

Operation 1050 may be performed as part (e.g., a precursor task, a subroutine, or a portion) of operation 550, in which the blockchain updater 240 updates the blockchain that corresponds to the social media user 410 to include a set of one or more data blocks that each indicates a corresponding social media follower (e.g., the first-order follower 421) among the verified subset of the social media followers. In example embodiments that include operation 1050, the notification generated in operation 510 additionally indicates a set of subtasks within the task that corresponds to the social media user 410.

In operation 1050, the blockchain updater 240 updates the blockchain that corresponds to the social media user 410 based on the corresponding portions of the set of subtasks for (e.g., performed by) each social media follower in the subset of the social media followers (e.g., first-order followers 420, 421, and 422) of the social media user 410. Continuing the above example where the generated notification indicates that the task to be performed is to create a personal video of oneself speaking a set of multiple keywords or catchphrases (e.g., a set of five (5) catchphrases) that corresponds to the social media user 410, and where the set of subtasks specify a different subtask for each keyword or catchphrase, the blockchain updater 240 may add (e.g., append) to the blockchain a set of one or more data blocks based on verified performances (e.g., verified by the task verifier 220 in operation 1030) performed by the social media followers in the verified subset of the social media followers (e.g., first-order followers 420, 421, and 422) of the social media user 410. As an example, the set of one or more data blocks may indicate that the first-order follower 420 created a personal video that depicts the first-order follower 420 speaking all of the multiple keywords or catchphrases (e.g., all five (5) out of five (5) catchphrases) that correspond to the social media user 410, may verify that the first-order follower 421 created a personal video that depicts the first-order follower 421 speaking only some and not all of the keywords or catchphrases (e.g., three (3) out of five (5) catchphrases), may verify that the first-order follower 422 failed to create such a personal video and thus failed to perform any of the multiple subtasks, or any suitable combination thereof.

According to various example embodiments, one or more of the methodologies described herein may facilitate incentivizing behavior among people, such as behavior of people engaged in playing a game (e.g., a social media game) facilitated (e.g., operated) in accordance with one or more of the systems and methods discussed herein. Moreover, one or more of the methodologies described herein may facilitate provision of rewards, penalties, amusement, recreation, entertainment, or any suitable combination thereof, to one or more first-order followers (e.g., first-order followers 420, 421, 422, and 423) of an entity (e.g., social media user 410, which may be a branded entity). Hence, one or more of the methodologies described herein may facilitate increases in public attention directed toward the entity (e.g., via one or more social media services), as well as create and maintain a human community based on shared interest in the entity, shared accomplishment of tasks corresponding to the entity, or both, compared to capabilities of pre-existing systems and methods.

When these effects are considered in aggregate, one or more of the methodologies described herein may obviate a need for certain efforts or resources that otherwise would be involved in facilitating at least some incentivizing of one or more behaviors among people, such as in playing a game (e.g., a social media game). Efforts expended by a user in playing or facilitating (e.g., operating or administering) such a game may be reduced by use of (e.g., reliance upon) a special-purpose machine that implements one or more of the methodologies described herein. Computing resources used by one or more systems or machines (e.g., within the network environment 100) may similarly be reduced (e.g., compared to systems or machines that lack the structures discussed herein or are otherwise unable to perform the functions discussed herein). Examples of such computing resources include processor cycles, network traffic, computational capacity, main memory usage, graphics rendering capacity, graphics memory usage, data storage capacity, power consumption, and cooling capacity.

FIG. 11 is a block diagram illustrating components of a machine 1100, according to some example embodiments, able to read instructions 1124 from a machine-readable medium 1122 (e.g., a non-transitory machine-readable medium, a machine-readable storage medium, a computer-readable storage medium, or any suitable combination thereof) and perform any one or more of the methodologies discussed herein, in whole or in part. Specifically, FIG. 11 shows the machine 1100 in the example form of a computer system (e.g., a computer) within which the instructions 1124 (e.g., software, a program, an application, an applet, an app, or other executable code) for causing the machine 1100 to perform any one or more of the methodologies discussed herein may be executed, in whole or in part.

In alternative embodiments, the machine 1100 operates as a standalone device or may be communicatively coupled (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a cellular telephone, a smart phone, a set-top box (STB), a personal digital assistant (PDA), a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include any collection of machines that individually or jointly execute the instructions 1124 to perform all or part of any one or more of the methodologies discussed herein.

The machine 1100 includes a processor 1102 (e.g., one or more central processing units (CPUs), one or more graphics processing units (GPUs), one or more digital signal processors (DSPs), one or more application specific integrated circuits (ASICs), one or more radio-frequency integrated circuits (RFICs), or any suitable combination thereof), a main memory 1104, and a static memory 1106, which are configured to communicate with each other via a bus 1108. The processor 1102 contains solid-state digital microcircuits (e.g., electronic, optical, or both) that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein. In some example embodiments, the processor 1102 is a multicore CPU (e.g., a dual-core CPU, a quad-core CPU, an 8-core CPU, or a 128-core CPU) within which each of multiple cores behaves as a separate processor that is able to perform any one or more of the methodologies discussed herein, in whole or in part. Although the beneficial effects described herein may be provided by the machine 1100 with at least the processor 1102, these same beneficial effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 1100 may further include a graphics display 1110 (e.g., a plasma display panel (PDP), a light emitting diode (LED) display, a liquid crystal display (LCD), a projector, a cathode ray tube (CRT), or any other display capable of displaying graphics or video). The machine 1100 may also include an alphanumeric input device 1112 (e.g., a keyboard or keypad), a pointer input device 1114 (e.g., a mouse, a touchpad, a touchscreen, a trackball, a joystick, a stylus, a motion sensor, an eye tracking device, a data glove, or other pointing instrument), a data storage 1116, an audio generation device 1118 (e.g., a sound card, an amplifier, a speaker, a headphone jack, or any suitable combination thereof), and a network interface device 1120.

The data storage 1116 (e.g., a data storage device) includes the machine-readable medium 1122 (e.g., a tangible and non-transitory machine-readable storage medium) on which are stored the instructions 1124 embodying any one or more of the methodologies or functions described herein. The instructions 1124 may also reside, completely or at least partially, within the main memory 1104, within the static memory 1106, within the processor 1102 (e.g., within the processor's cache memory), or any suitable combination thereof, before or during execution thereof by the machine 1100. Accordingly, the main memory 1104, the static memory 1106, and the processor 1102 may be considered machine-readable media (e.g., tangible and non-transitory machine-readable media). The instructions 1124 may be transmitted or received over the network 190 via the network interface device 1120. For example, the network interface device 1120 may communicate the instructions 1124 using any one or more transfer protocols (e.g., hypertext transfer protocol (HTTP)).

In some example embodiments, the machine 1100 may be a portable computing device (e.g., a smart phone, a tablet computer, or a wearable device) and may have one or more additional input components 1130 (e.g., sensors or gauges). Examples of such input components 1130 include an image input component (e.g., one or more cameras), an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), a temperature input component (e.g., a thermometer), and a gas detection component (e.g., a gas sensor). Input data gathered by any one or more of these input components 1130 may be accessible and available for use by any of the modules described herein (e.g., with suitable privacy notifications and protections, such as opt-in consent or opt-out consent, implemented in accordance with user preference, applicable regulations, or any suitable combination thereof).

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of carrying (e.g., storing or communicating) the instructions 1124 for execution by the machine 1100, such that the instructions 1124, when executed by one or more processors of the machine 1100 (e.g., processor 1102), cause the machine 1100 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof.

A “non-transitory” machine-readable medium, as used herein, specifically excludes propagating signals per se. According to various example embodiments, the instructions 1124 for execution by the machine 1100 can be communicated via a carrier medium (e.g., a machine-readable carrier medium). Examples of such a carrier medium include a non-transient carrier medium (e.g., a non-transitory machine-readable storage medium, such as a solid-state memory that is physically movable from one place to another place) and a transient carrier medium (e.g., a carrier wave or other propagating signal that communicates the instructions 1124).

Certain example embodiments are described herein as including modules. Modules may constitute software modules (e.g., code stored or otherwise embodied in a machine-readable medium or in a transmission medium), hardware modules, or any suitable combination thereof. A “hardware module” is a tangible (e.g., non-transitory) physical component (e.g., a set of one or more processors) capable of performing certain operations and may be configured or arranged in a certain physical manner. In various example embodiments, one or more computer systems or one or more hardware modules thereof may be configured by software (e.g., an application or portion thereof) as a hardware module that operates to perform operations described herein for that module.

In some example embodiments, a hardware module may be implemented mechanically, electronically, hydraulically, or any suitable combination thereof. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering example embodiments in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory (e.g., a memory device) to which it is communicatively coupled. A further hardware module may then, at a later time, access the memory to retrieve and process the stored output. Hardware modules may also initiate communications with input or output devices, and can operate on a resource (e.g., a collection of information from a computing resource).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module in which the hardware includes one or more processors. Accordingly, the operations described herein may be at least partially processor-implemented, hardware-implemented, or both, since a processor is an example of hardware, and at least some operations within any one or more of the methods discussed herein may be performed by one or more processor-implemented modules, hardware-implemented modules, or any suitable combination thereof.

Moreover, such one or more processors may perform operations in a “cloud computing” environment or as a service (e.g., within a “software as a service” (SaaS) implementation). For example, at least some operations within any one or more of the methods discussed herein may be performed by a group of computers (e.g., as examples of machines that include processors), with these operations being accessible via a network (e.g., the Internet) and via one or more appropriate interfaces (e.g., an application program interface (API)). The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

Some portions of the subject matter discussed herein may be presented in terms of algorithms or symbolic representations of operations on data stored as bits or binary digital signals within a memory (e.g., a computer memory or other machine memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “accessing,” “processing,” “detecting,” “computing,” “calculating,” “determining,” “generating,” “presenting,” “displaying,” or the like refer to actions or processes performable by a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated descriptions describe various examples of methods, machine-readable media, and systems (e.g., machines, devices, or other apparatus) discussed herein. Any one or more features of an example, taken in isolation or combination, should be considered as being within the disclosure of this application.

A first example provides a method comprising:
generating, by one or more processors, a notification that social media followers of a social media user with a corresponding blockchain will obtain consequences for performing a task that corresponds to the social media user;
providing, by the one or more processors, the generated notification to at least a portion of the social media followers of the social media user that corresponds to the blockchain;
verifying, by the one or more processors, that a subset of the social media followers performed the task that corresponds to the social media user, each to a corresponding extent of performance of the task;
determining, by the one or more processors, for each social media follower in the verified subset of the social media followers, a corresponding consequence based on the corresponding extent of performance of the task performed by that social media follower; and updating, by the one or more processors, the blockchain that corresponds to the social media user to include a set of one or more data blocks that each indicates a corresponding social media follower among the verified subset of the social media followers, the corresponding extent of performance of the task performed by that social media follower, and the determined corresponding consequence for that social media follower.

A second example provides a method according to the first example, wherein:
the generated notification indicates that the consequences for performing the task include rewards; and
the determining, for each social media follower in the verified subset of the social media followers, of the corresponding consequence includes determining, for a first social media follower among the verified subset, a corresponding reward based on the corresponding extent of performance of the task performed by that first social media follower.

A third example provides a method according to the first example or the second example, wherein:
the generated notification indicates that the consequences for performing the task include penalties; and
the determining, for each social media follower in the verified subset of the social media followers, of the corresponding consequence includes determining, for a first social media follower among the verified subset, a corresponding penalty based on the corresponding extent of performance of the task performed by that first social media follower.

A fourth example provides a method according to any of the first through third examples, wherein:

the verifying that the subset of the social media followers performed the task includes:
receiving a first social media submission from a first device of a first social media follower of the social media user;
determining that the first social media submission includes at least one of speech content specified in the generated notification, image content specified in the generated notification, or video content specified in the generated notification; and causing publication of the first social media submission by a first social media account that corresponds to the first social media follower of the social media user.

A fifth example provides a method according to any of the first through fourth examples, wherein:

the verifying that the subset of the social media followers performed the task includes:

monitoring a first social media account that corresponds to a first social media follower of the social media user; and
determining that a first social media publication by the first social media account includes at least one of speech content specified in the generated notification, image content specified in the generated notification, or video content specified in the generated notification.

A sixth example provides a method according to any of the first through fifth examples, wherein:
the social media followers of the social media user are first-order followers of the social media user;
a first-order follower among the first-order followers has second-order followers of the first-order follower; and
the determining of the corresponding consequence for the first-order follower is based on at least one published reaction by at least one of the second-order followers to the corresponding performance of the task by the first-order follower.

A seventh example provides a method according to any of the first through sixth examples, wherein:
the generated notification indicates a set of subtasks within the task that corresponds to the social media user;
the verifying that the subset of the social media followers each performed the task to the corresponding extent of performance is based on a corresponding portion of the set of subtasks for each social media follower in the subset of the social media followers; and the updating of the blockchain that corresponds to the social media user is based on the corresponding portions of the set of subtasks for each social media follower in the subset of the social media followers.

An eighth example provides a machine-readable medium (e.g., a non-transitory machine-readable storage medium) comprising instructions that, when executed by one or more processors of a machine, cause the machine to perform operations comprising:
generating a notification that social media followers of a social media user with a corresponding blockchain will obtain consequences for performing a task that corresponds to the social media user;
providing the generated notification to at least a portion of the social media followers of the social media user that corresponds to the blockchain;
verifying that a subset of the social media followers performed the task that corresponds to the social media user, each to a corresponding extent of performance of the task;
determining, for each social media follower in the verified subset of the social media followers, a corresponding consequence based on the corresponding extent of performance of the task performed by that social media follower; and updating the blockchain that corresponds to the social media user to include a set of one or more data blocks that each indicates a corresponding social media follower among the verified subset of the social media followers, the corresponding extent of performance of the task performed by that social media follower, and the determined corresponding consequence for that social media follower.

A ninth example provides a machine-readable medium according to the eighth example, wherein:

the generated notification indicates that the consequences for performing the task include rewards; and

the determining, for each social media follower in the verified subset of the social media followers, of the corresponding consequence includes determining, for a first social media follower among the verified subset, a corresponding reward based on the corresponding extent of performance of the task performed by that first social media follower.

A tenth example provides a machine-readable medium according to the eight example or the ninth example, wherein:
the generated notification indicates that the consequences for performing the task include penalties; and
the determining, for each social media follower in the verified subset of the social media followers, of the corresponding consequence includes determining, for a first social media follower among the verified subset, a corresponding penalty based on the corresponding extent of performance of the task performed by that first social media follower.

An eleventh example provides a machine-readable medium according to any of the eighth through tenth examples, wherein:

the verifying that the subset of the social media followers performed the task includes:

receiving a first social media submission from a first device of a first social media follower of the social media user;
determining that the first social media submission includes at least one of speech content specified in the generated notification, image content specified in the generated notification, or video content specified in the generated notification; and causing publication of the first social media submission by a first social media account that corresponds to the first social media follower of the social media user.

A twelfth example provides a machine-readable medium according to any of the eighth through eleventh examples, wherein:

the verifying that the subset of the social media followers performed the task includes:

monitoring a first social media account that corresponds to a first social media follower of the social media user; and

determining that a first social media publication by the first social media account includes at least one of speech content specified in the generated notification, image content specified in the generated notification, or video content specified in the generated notification.

A thirteenth example provides a machine-readable medium accordingly to any of the eighth through twelfth examples, wherein:
the social media followers of the social media user are first-order followers of the social media user;
a first-order follower among the first-order followers has second-order followers of the first-order follower; and
the determining of the corresponding consequence for the first-order follower is based on at least one published reaction by at least one of the second-order followers to the corresponding performance of the task by the first-order follower.

A fourteenth example provides a machine-readable medium accordingly to any of the eighth through thirteenth examples, wherein:
the generated notification indicates a set of subtasks within the task that corresponds to the social media user;
the verifying that the subset of the social media followers each performed the task to the corresponding extent of performance is based on a corresponding portion of the set of subtasks for each social media follower in the subset of the social media followers; and the updating of the blockchain that corresponds to the social media user is based on the corresponding portions of the set of subtasks for each social media follower in the subset of the social media followers.

A fifteenth example provides a system (e.g., a computer system of one or more machines) comprising:
one or more processors; and
a memory storing instructions that, when executed by at least one processor among the one or more processors, cause the system to perform operations comprising:
generating a notification that social media followers of a social media user with a corresponding blockchain will obtain consequences for performing a task that corresponds to the social media user;
providing the generated notification to at least a portion of the social media followers of the social media user that corresponds to the blockchain;
verifying that a subset of the social media followers performed the task that corresponds to the social media user, each to a corresponding extent of performance of the task;
determining, for each social media follower in the verified subset of the social media followers, a corresponding consequence based on the corresponding extent of performance of the task performed by that social media follower; and updating the blockchain that corresponds to the social media user to include a set of one or more data blocks that each indicates a corresponding social media follower among the verified subset of the social media followers, the corresponding extent of performance of the task performed by that social media follower, and the determined corresponding consequence for that social media follower.

A sixteenth example provides a system according to the fifteenth example, wherein:
the generated notification indicates that the consequences for performing the task include rewards; and
the determining, for each social media follower in the verified subset of the social media followers, of the corresponding consequence includes determining, for a first social media follower among the verified subset, a corresponding reward based on the corresponding extent of performance of the task performed by that first social media follower.

A seventeenth example provides a system according to the fifteenth example or the sixteenth example, wherein:

the verifying that the subset of the social media followers performed the task includes:

receiving a first social media submission from a first device of a first social media follower of the social media user;
determining that the first social media submission includes at least one of speech content specified in the generated notification, image content specified in the generated notification, or video content specified in the generated notification; and causing publication of the first social media submission by a first social media account that corresponds to the first social media follower of the social media user.

An eighteenth example provides a system according to any of the fifteenth through seventeenth examples, wherein:

the verifying that the subset of the social media followers performed the task includes:

monitoring a first social media account that corresponds to a first social media follower of the social media user; and
determining that a first social media publication by the first social media account includes at least one of speech content specified in the generated notification, image content specified in the generated notification, or video content specified in the generated notification.

A nineteenth example provides a system according to any of the fifteenth through eighteenth examples, wherein:
the social media followers of the social media user are first-order followers of the social media user;
a first-order follower among the first-order followers has second-order followers of the first-order follower; and
the determining of the corresponding consequence for the first-order follower is based on at least one published reaction by at least one of the second-order followers to the corresponding performance of the task by the first-order follower.

A twentieth example provides a system according to any of the fifteenth through nineteenth examples, wherein:
the generated notification indicates a set of subtasks within the task that corresponds to the social media user;
the verifying that the subset of the social media followers each performed the task to the corresponding extent of performance is based on a corresponding portion of the set of subtasks for each social media follower in the subset of the social media followers; and the updating of the blockchain that corresponds to the social media user is based on the corresponding portions of the set of subtasks for each social media follower in the subset of the social media followers.

A twenty-first example provides a carrier medium carrying machine-readable instructions for controlling a machine to carry out the operations (e.g., method operations) performed in any one of the previously described examples.

What is claimed is:

1. A method comprising:
generating, by one or more processors, a notification that social media followers of a social media user with a corresponding blockchain will obtain consequences for performing a task that corresponds to the social media user;
providing, by the one or more processors, the generated notification to at least a portion of the social media followers of the social media user that corresponds to the blockchain;
verifying, by the one or more processors, that a subset of the social media followers performed the task that corresponds to the social media user, each to a corresponding extent of performance of the task;
determining, by the one or more processors, for each social media follower in the verified subset of the social media followers, a corresponding consequence based on the corresponding extent of performance of the task performed by that social media follower; and
updating, by the one or more processors, the blockchain that corresponds to the social media user to include a set of one or more data blocks that each indicates a corresponding social media follower among the verified subset of the social media followers, the corresponding extent of performance of the task performed by that social media follower, and the determined corresponding consequence for that social media follower.

2. The method of claim 1, wherein:
the generated notification indicates that the consequences for performing the task include rewards; and
the determining, for each social media follower in the verified subset of the social media followers, of the corresponding consequence includes determining, for a first social media follower among the verified subset, a corresponding reward based on the corresponding extent of performance of the task performed by that first social media follower.

3. The method of claim 1, wherein:
the generated notification indicates that the consequences for performing the task include penalties; and
the determining, for each social media follower in the verified subset of the social media followers, of the corresponding consequence includes determining, for a first social media follower among the verified subset, a corresponding penalty based on the corresponding extent of performance of the task performed by that first social media follower.

4. The method of claim 1, wherein:
the verifying that the subset of the social media followers performed the task includes:
receiving a first social media submission from a first device of a first social media follower of the social media user;
determining that the first social media submission includes at least one of speech content specified in the generated notification, image content specified in the generated notification, or video content specified in the generated notification; and
causing publication of the first social media submission by a first social media account that corresponds to the first social media follower of the social media user.

5. The method of claim 1, wherein:
the verifying that the subset of the social media followers performed the task includes:
monitoring a first social media account that corresponds to a first social media follower of the social media user; and
determining that a first social media publication by the first social media account includes at least one of speech content specified in the generated notification, image content specified in the generated notification, or video content specified in the generated notification.

6. The method of claim 1, wherein:
the social media followers of the social media user are first-order followers of the social media user;
a first-order follower among the first-order followers has second-order followers of the first-order follower; and
the determining of the corresponding consequence for the first-order follower is based on at least one published reaction by at least one of the second-order followers to the corresponding performance of the task by the first-order follower.

7. The method of claim 1, wherein:
the generated notification indicates a set of subtasks within the task that corresponds to the social media user;
the verifying that the subset of the social media followers each performed the task to the corresponding extent of performance is based on a corresponding portion of the set of subtasks for each social media follower in the subset of the social media followers; and
the updating of the blockchain that corresponds to the social media user is based on the corresponding portions of the set of subtasks for each social media follower in the subset of the social media followers.

8. A non-transitory machine-readable storage medium comprising instructions that, when executed by one or more processors of a machine, cause the machine to perform operations comprising:
generating a notification that social media followers of a social media user with a corresponding blockchain will obtain consequences for performing a task corresponds to the social media user;
providing the generated notification to at least a portion of the social media followers of the social media user that corresponds to the blockchain;
verifying that a subset of the social media followers performed the task that corresponds to the social media user, each to a corresponding extent of performance of the task;
determining, for each social media follower in the verified subset of the social media followers, a corresponding consequence based on the corresponding extent of performance of the task performed by that social media follower; and
updating the blockchain that corresponds to the social media user to include a set of one or more data blocks that each indicates a corresponding social media follower among the verified subset of the social media followers, the corresponding extent of performance of the task performed by that social media follower, and the determined corresponding consequence for that social media follower.

9. The non-transitory machine-readable storage medium of claim 8, wherein:
the generated notification indicates that the consequences for performing the task include rewards; and
the determining, for each social media follower in the verified subset of the social media followers, of the corresponding consequence includes determining, for a first social media follower among the verified subset, a corresponding reward based on the corresponding extent of performance of the task performed by that first social media follower.

10. The non-transitory machine-readable storage medium of claim 8, wherein:
the generated notification indicates that the consequences for performing the task include penalties; and
the determining, for each social media follower in the verified subset of the social media followers, of the corresponding consequence includes determining, for a first social media follower among the verified subset, a corresponding penalty based on the corresponding extent of performance of the task performed by that first social media follower.

11. The non-transitory machine-readable storage medium of claim 8, wherein:
the verifying that the subset of the social media followers performed the task includes:
receiving a first social media submission from a first device of a first social media follower of the social media user;
determining that the first social media submission includes at least one of speech content specified in the generated notification, image content specified in the generated notification, or video content specified in the generated notification; and
causing publication of the first social media submission by a first social media account that corresponds to the first social media follower of the social media user.

12. The non-transitory machine-readable storage medium of claim 8, wherein:
the verifying that the subset of the social media followers performed the task includes:
monitoring a first social media account that corresponds to a first social media follower of the social media user; and
determining that a first social media publication by the first social media account includes at least one of speech content specified in the generated notification, image content specified in the generated notification, or video content specified in the generated notification.

13. The non-transitory machine-readable storage medium of claim 8, wherein:
the social media followers of the social media user are first-order followers of the social media user;
a first-order follower among the first-order followers has second-order followers of the first-order follower; and
the determining of the corresponding consequence for the first-order follower is based on at least one published reaction by at least one of the second-order followers to the corresponding performance of the task by the first-order follower.

14. The non-transitory machine-readable storage medium of claim 8, wherein:
the generated notification indicates a set of subtasks within the task that corresponds to the social media user;
the verifying that the subset of the social media followers each performed the task to the corresponding extent of performance is based on a corresponding portion of the set of subtasks for each social media follower in the subset of the social media followers; and
the updating of the blockchain that corresponds to the social media user is based on the corresponding portions of the set of subtasks for each social media follower in the subset of the social media followers.

15. A system comprising:
one or more processors; and
a memory storing instructions that, when executed by at least one processor among the one or more processors, cause the system to perform operations comprising:
generating a notification that social media followers of a social media user with a corresponding blockchain will obtain consequences for performing a task corresponds to the social media user;
providing the generated notification to at least a portion of the social media followers of the social media user that corresponds to the blockchain;
verifying that a subset of the social media followers performed the task that corresponds to the social media user, each to a corresponding extent of performance of the task;
determining, for each social media follower in the verified subset of the social media followers, a corresponding consequence based on the corresponding extent of performance of the task performed by that social media follower; and
updating the blockchain that corresponds to the social media user to include a set of one or more data blocks that each indicates a corresponding social media follower among the verified subset of the social media followers, the corresponding extent of performance of the task performed by that social media follower, and the determined corresponding consequence for that social media follower.

16. The system of claim 15, wherein:
the generated notification indicates that the consequences for performing the task include rewards; and
the determining, for each social media follower in the verified subset of the social media followers, of the corresponding consequence includes determining, for a first social media follower among the verified subset, a corresponding reward based on the corresponding extent of performance of the task performed by that first social media follower.

17. The system of claim 15, wherein:
the verifying that the subset of the social media followers performed the task includes:
receiving a first social media submission from a first device of a first social media follower of the social media user;
determining that the first social media submission includes at least one of speech content specified in the generated notification, image content specified in the generated notification, or video content specified in the generated notification; and
causing publication of the first social media submission by a first social media account that corresponds to the first social media follower of the social media user.

18. The system of claim 15, wherein:
the verifying that the subset of the social media followers performed the task includes:
monitoring a first social media account that corresponds to a first social media follower of the social media user; and
determining that a first social media publication by the first social media account includes at least one of speech content specified in the generated notification, image content specified in the generated notification, or video content specified in the generated notification.

19. The system of claim 15, wherein:
the social media followers of the social media user are first-order followers of the social media user;
a first-order follower among the first-order followers has second-order followers of the first-order follower; and
the determining of the corresponding consequence for the first-order follower is based on at least one published reaction by at least one of the second-order followers to the corresponding performance of the task by the first-order follower.

20. The system of claim 15, wherein:
the generated notification indicates a set of subtasks within the task that corresponds to the social media user;
the verifying that the subset of the social media followers each performed the task to the corresponding extent of performance is based on a corresponding portion of the set of subtasks for each social media follower in the subset of the social media followers; and
the updating of the blockchain that corresponds to the social media user is based on the corresponding portions of the set of subtasks for each social media follower in the subset of the social media followers.
